(19) United States
(12) Patent Application Publication
(10) Pub. No.: US 2026/0170350 A1
(43) Pub. Date: Jun. 18, 2026

(54) Network Management Using a Network Foundation Model

(71) Applicant: AT&T Intellectual Property I, L.P., Atlanta, GA (US)

(72) Inventors: Zhengyi Zhou, Chappaqua, NY (US); Divesh Srivastava, Summit, NJ (US); Yaron Kanza, Fair Lawn, NJ (US)

(73) Assignee: AT&T Intellectual Property I, L.P., Atlanta, GA (US)

(21) Appl. No.: 18/978,056

(22) Filed: Dec. 12, 2024

(51) Int. Cl. G06N 3/0985; G06N 3/042

(52) U.S. Cl. CPC G06N 3/0985; G06N 3/042

(57) ABSTRACT

Network management using a network foundation model can include selecting, in a directed graph, a component that corresponds to a node on a network, the component being connected to an edge that corresponds to a communication link on the network and the edge having a weight that represents a probability that traffic flows from the node to a further node via the communication link. A walker can be placed on the component and can capture a state, an identity, a time and other information. The walker can select a next component based on weights of edges and the walker can traverse the network via a highest weighted edge. The walker can again collect state, identity, and time information at the new node. A sequence can be output and the network foundation model can be trained based on the sequence.

### BACKGROUND

Network data can be highly dynamic and some aspects of network data may rapidly change. For example, physical connections between network nodes may seldom change but the route of network flows between two given nodes may change frequently. It also may be a challenge to capture temporal aspects of network data, correlations between network components, and effects of changes in some parts of the network on other parts of the network.

### SUMMARY

The present disclosure is directed to network management using a network foundation model. According to various embodiments of the concepts and technologies disclosed herein, as will be explained in more detail hereinbelow, a “network foundation model” can refer to a machine learning (e.g., a deep learning) model that can be trained on vast datasets, thereby allowing the network foundation model to be applied across a wide range of use cases as will be more evident from the description herein. Similarly, it should be noted that the term “network” used herein, when used generically and not as part of the phrase “network foundation model,” can be used to refer to a communication network and/or a computer network or the like, and does not include a neural network. In practice, a network management service can be hosted and/or executed by a device or resource such as a server computer. The network management service can be configured to detect a request to create a network foundation model, which can model entities (e.g., nodes, communication links, and the like) on a network and/or a portion thereof, as well as traffic flows and/or patterns across the network and/or a portion thereof. The network foundation model can include and/or can be based on a network topology and a network-flow model in some embodiments. It should be understood that this example embodiment is illustrative, and therefore should not be construed as being limiting in any way.

The network management service can obtain, from a data store, a network monitor, and/or other sources, a network data that can describe the network, entities such as nodes operating on the network, communication links between the nodes, events occurring on the network, traffic flows and/or patterns on the network, other aspects of the network, combinations thereof, or the like. The network management service can create, based on the network data, a network topology (e.g., a direct graph including components that represent the nodes and edges that represent the communication links) and a network-flow model that represents traffic flows and/or events on the network. The network management service can define possible states for the nodes and the communication links, and perform a process to collect state for the nodes. It should be understood that this example embodiment is illustrative, and therefore should not be construed as being limiting in any way.

To collect the state for the nodes, the network management service can locate a walker (e.g., a software probe, a process run by the network management service, or the like) on a component of the directed graph that corresponds to a node. According to various embodiments of the concepts and technologies disclosed herein, a “walker” may be used to create sequences of states that can represent the status of network components over time in various conditions. Thus, for example, a network operator may wish to represent, for example, what happens to a particular network node over time in some situation or upon some event; the effect of a particular node on neighboring nodes; the effect of an event in a node on the state of neighboring nodes; combinations thereof; or the like. Similarly, sequences can be a natural input for some machine learning models such as, for example, recurrent neural networks (“RNNs”), long short-term memory (“LSTM”) models, model transformers or transformer models (also referred to as “transformers”), or the like. In some embodiments, a goal can include a desire to extract sequences (e.g., from a model of the network) in a stochastic manner, to have a comprehensive representation of the network and of the mutual effects of nodes on one another. It should be understood that this example embodiment is illustrative, and therefore should not be construed as being limiting in any way.

The node can be selected at random, based on instructions, based on other considerations, or the like. The walker can capture state, node identity, time, other information, and the like for the node. The walker can then identify weights for edges that connect to the component, with the edges corresponding to the communication links that connect to the node. A next component can be determined (with the next component corresponding to the next node) based on the weights. In some embodiments, the edge with the highest weight (e.g., corresponding to a highest utilization, a highest probability that traffic will flow via that edge, or the like) can be identified based on the weights and a next component on that edge can be determined. If the next component is not available, a new next component can be identified (e.g., along the edge having the next highest weight, or the like). Once a next component that is identified is determined to be available, the walker can traverse to the next component (e.g., corresponding to the next node) and again capture state, node identity, time, and/or other information. It should be understood that this example embodiment is illustrative, and therefore should not be construed as being limiting in any way.

It should be understood that in various embodiments of the concepts and technologies disclosed herein, the selection of a next component (or node) can be stochastic as opposed to deterministic. For example, in some embodiments the next component (or node) can be determined based on determining a probability of walking from a particular node along a particular edge having a weight that can be, for example, the weight divided by the sum of the weights of all edges incident on the node. It should be understood that this example embodiment is illustrative, and therefore should not be construed as being limiting in any way. In another example, the walker may select a next component (node) in some manner that may be affected by a routing table associated with and/or stored by the current node and/or a routing protocol such as, for example, open shortest path first (“OSPF”), border gateway protocol (“BGP”), combinations thereof, or the like. Because the next component (node) can be determined in additional and/or alternative deterministic, stochastic, and/or other manners, it should be understood that these example embodiments are illustrative, and therefore should not be construed as being limiting in any way.

The walker can determine if criteria (for the modeling) have been met. In some embodiments, criteria can be specified for the network foundation model creation and the walker can determine if the criteria have been met. If the criteria have not been met, the walker can again determine edge weights and a next node can be determined. Thus, the modeling can continue until the walker determines that the criteria have been met. If the walker determines that the criteria have been met, the walker can output the determined sequence from the walker. Multiple sequences can be created for the network and/or a portion thereof by one or more walkers, which can be instantiated at any time. The sequences can be added to a dataset, and the network management service can train the network foundation model on the dataset. It should be understood that this example embodiment is illustrative, and therefore should not be construed as being limiting in any way.

Hypothetical scenarios can be fed to the network foundation model. For example, model input can be received (for example, from the user device) and the model input can be fed to the network foundation model. The network foundation model can process the model input to create output and the network management service can provide the model output to the user device or other device that created the model input. In some example embodiments, this processing can be based on learned statistics such as generative artificial intelligence (“GenAI”) tools such as, for example, selection of the next word in a large language model (“LLM”) based on statistics or the like (e.g., in a manner that may differ from classical algorithms that may make decisions based on pre-defined logic, or the like). Thus, it should be understood that in some embodiments, the output can be created based on learned statistics about the network. It should be understood that this example embodiment is illustrative, and therefore should not be construed as being limiting in any way.

A command can be received by the network management service, with the command corresponding to instructions based on the model output (e.g., selections or input created at the user device and/or the like). The network management service can receive the command and generate a network command. The network management service can send the network command to the network controller, and based on the network command, the network controller can manage the network (e.g., implement changes to the network or a portion thereof). It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include selecting, in a directed graph representing a network topology, a component that corresponds to a node on a network. The component can be connected to an edge that can correspond to a communication link on the network. The edge can have a weight that represents a probability that traffic flows from the node to a further node via the communication link. The operations can further include placing, on the component, a walker that can collect, by the walker and at the component, a state of the node, an identity of the node, and a time at which the state is collected; determining, at the component, the weight; and selecting, by the walker, a next component based on the weight. The walker can traverse the network via the edge if the next component is available, and the walker can select a different component based on the weight if the next component is not available. The operations further can include collecting, by the walker and at the next component, a further state of a further node, a further identity of the further node, and a further time at which the further state is collected; outputting, by the walker, a sequence that reflects the state of the node, the time at which the state of the node is collected, the further state of the further node, and the further time at which the further state is collected; and training, based on the sequence, a network foundation model for the network.

In some embodiments, the operations can further include determining, by the walker, if criteria specified for the walker are met; and in response to determining that the criteria specified for the walker are not met, determining edge weights for edges that connect to the further node and again traversing the network via a highest weighted edge of the edges. In some embodiments, the edge weights can be based on measured features of the connection such as, for example, network traffic, throughput, delay, combinations thereof, or the like. It should be understood that this example embodiment is illustrative, and therefore should not be construed as being limiting in any way. In some embodiments, the operations can further include receiving, from a requestor, model input that represents a hypothetical network scenario; feeding, to the network foundation model, the model input to obtain model output; providing the model output to the requestor; and receiving, from the requestor and based on the model output, a command that specifies an action to take on the network based on the model output.

In some embodiments, the operations can further include generating, based on the command, a network command including instructions that, when executed by a network controller, cause the network controller to modify the network (or, for example, a state of the network); and providing, to the network controller, the network command. In some embodiments, the operations can further include detecting a request to create the network foundation model; obtaining network data that describes nodes of a network, communication links between the nodes, and events at the nodes and communication links; and creating a network topology and network-flow model based on the network data. The network foundation model can be generated based on the network topology and the network-flow model. In some embodiments, the network topology can include the directed graph, and the network-flow model can describe traffic among nodes of the network. In some embodiments, the network data can be obtained from a network monitor that outputs a stream of events occurring on the network, and the network data can include netflow data.

According to another aspect of the concepts and technologies disclosed herein, a method is disclosed. The method can include selecting, by a computer including a processor that provides a walker and in a directed graph representing a network topology, a component that corresponds to a node on a network. The component can be connected to an edge that can correspond to a communication link on the network. The edge can have a weight that represents a probability that traffic flows from the node to a further node via the communication link. The method can further include placing, by the processor and on the component, a walker that can collect, by the walker and at the component, a state of the node, an identity of the node, and a time at which the state is collected; determining, by the processor and at the component, the weight; and selecting, by the walker, a next component based on the weight. The walker can traverse the network via the edge if the next component is available, and the walker can select a different component based on the weight if the next component is not available. The method further can include collecting, by the walker and at the next component, a further state of a further node, a further identity of the further node, and a further time at which the further state is collected; outputting, by the walker, a sequence that reflects the state of the node, the time at which the state of the node is collected, the further state of the further node, and the further time at which the further state is collected; and training, based on the sequence, a network foundation model for the network.

In some embodiments, the operations can further include determining, by the walker, if criteria specified for the walker are met; and in response to determining that the criteria specified for the walker are not met, determining edge weights for edges that connect to the further node(s) and again traversing the network via a highest weighted edge of the edges connected to the current node. In some embodiments, the operations can further include receiving, from a requestor, model input that represents a hypothetical network scenario; feeding, to the network foundation model, the model input to obtain model output; providing the model output to the requestor; and receiving, from the requestor and based on the model output, a command that specifies an action to take on the network based on the model output. It should be understood that in some embodiments, the command is one type of action. Other actions can include, for example, an answer to a question (e.g., a hypothetical question) about the network. It should be understood that this example embodiment is illustrative, and therefore should not be construed as being limiting in any way.

In some embodiments, the operations can further include generating, based on the command, a network command including instructions that, when executed by a network controller, cause the network controller to modify the network; and providing, to the network controller, the network command. In some embodiments, the operations can further include detecting a request to create the network foundation model; obtaining network data that describes nodes of a network, communication links between the nodes, and events at the nodes and communication links; and creating a network topology and network-flow model based on the network data. The network foundation model can be generated based on the network topology and the network-flow model. In some embodiments, the network topology can include the directed graph, and the network-flow model can describe traffic among nodes of the network. In some embodiments, the network data can be obtained from a network monitor that outputs a stream of events occurring on the network, and the network data can include netflow data. In some instances, the network data can include, for example, real data (e.g., measurements and/or other types of data that can be collected by monitoring the network, reporting on the network, or the like), synthetic data that can be produced by a simulation of the network (e.g., by models, algorithms, or the like), and/or by a combination of measurement and synthetic data. It should be understood that this example embodiment is illustrative, and therefore should not be construed as being limiting in any way.

According to yet another aspect of the concepts and technologies disclosed herein, a computer storage medium is disclosed. The computer storage medium can store computer-executable instructions that, when executed by a processor, cause the processor to perform operations. The operations can include selecting, in a directed graph representing a network topology, a component that corresponds to a node on a network. The component can be connected to an edge that can correspond to a communication link on the network. The edge can have a weight that represents a probability that traffic flows from the node to a further node via the communication link. The operations can further include placing, on the component, a walker that can collect, by the walker and at the component, a state of the node, an identity of the node, and a time at which the state is collected; determining, at the component, the weight; and selecting, by the walker, a next component based on the weight. The walker can traverse the network via the edge if the next component is available, and the walker can select a different component based on the weight if the next component is not available. The operations further can include collecting, by the walker and at the next component, a further state of a further node, a further identity of the further node, and a further time at which the further state is collected; outputting, by the walker, a sequence that reflects the state of the node, the time at which the state of the node is collected, the further state of the further node, and the further time at which the further state is collected; and training, based on the sequence, a network foundation model for the network.

In some embodiments, the operations can further include determining, by the walker, if criteria specified for the walker are met; and in response to determining that the criteria specified for the walker are not met, determining edge weights for edges that connect to the further node and again traversing the network via a highest weighted edge of the edges. In some embodiments, the operations can further include receiving, from a requestor, model input that represents a hypothetical network scenario; feeding, to the network foundation model, the model input to obtain model output; providing the model output to the requestor; and receiving, from the requestor and based on the model output, a command that specifies an action to take on the network based on the model output.

In some embodiments, the operations can further include generating, based on the command, a network command including instructions that, when executed by a network controller, cause the network controller to modify the network; and providing, to the network controller, the network command. In some embodiments, the operations can further include detecting a request to create the network foundation model; obtaining network data that describes nodes of a network, communication links between the nodes, and events at the nodes and communication links; and creating a network topology and network-flow model based on the network data. The network foundation model can be generated based on the network topology and the network-flow model. In some embodiments, the network topology can include the directed graph, and the network-flow model can describe traffic among nodes of the network. In some embodiments, the network data can be obtained from a network monitor that outputs a stream of events occurring on the network, and the network data can include netflow data. In some embodiments, it should be understood that the network data can include synthetic data about the network and may not be reported by a network monitor or other device. It should be understood that this example embodiment is illustrative, and therefore should not be construed as being limiting in any way.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIGS. 2A-2F are line drawings illustrating aspects of creating the network foundation model, according to an illustrative embodiment of the concepts and technologies disclosed herein.

FIG. 3 is a flow diagram showing aspects of a method for creating or updating a network foundation model, according to an illustrative embodiment of the concepts and technologies described herein.

FIG. 4 is a flow diagram showing aspects of a method for collecting node state for all network nodes, according to an illustrative embodiment of the concepts and technologies described herein.

FIG. 5 is a flow diagram showing aspects of a method for using a network foundation model to manage a network, according to an illustrative embodiment of the concepts and technologies described herein.

FIG. 6 schematically illustrates a network, according to an illustrative embodiment of the concepts and technologies described herein.

FIG. 7 is a block diagram illustrating an example computer system configured to provide network management using a network foundation model, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to network management using a network foundation model. A network management service can be hosted and/or executed by a device or resource such as a server computer. The network management service can be configured to detect a request to create a network foundation model, which can model entities (e.g., nodes, communication links, and the like) on a network and/or a portion thereof, as well as traffic flows and/or patterns across the network and/or a portion thereof. The network foundation model can include and/or can be based on a network topology and a network-flow model in some embodiments. It should be understood that this example embodiment is illustrative, and therefore should not be construed as being limiting in any way.

The network management service can obtain, from a data store, a network monitor, and/or other sources, a network data that can describe the network, entities such as nodes operating on the network, communication links between the nodes, events occurring on the network, traffic flows and/or patterns on the network, other aspects of the network, combinations thereof, or the like. The network management service can create, based on the network data, a network topology (e.g., a direct graph including components that represent the nodes and edges that represent the communication links) and a network-flow model that represents traffic flows and/or events on the network. The network management service can define possible states for the nodes and the communication links, and perform a process to collect state for the nodes. It should be understood that this example embodiment is illustrative, and therefore should not be construed as being limiting in any way.

To collect the state for the nodes, the network management service can locate a walker (e.g., a software probe, a process run by the network management service, or the like) on a component of the directed graph that corresponds to a node. The node can be selected at random, based on instructions, based on other considerations, or the like. The walker can capture state, node identity, time, other information, and the like for the node. The walker can then identify weights for edges that connect to the component, with the edges corresponding to the communication links that connect to the node. A next component can be determined (with the next component corresponding to the next node) based on the weights. In some embodiments, the edge with the highest weight (e.g., corresponding to a highest utilization, a highest probability that traffic will flow via that edge, or the like) can be identified based on the weights and a next component on that edge can be determined. If the next component is not available, a new next component can be identified (e.g., along the edge having the next highest weight, or the like). Once a next component that is identified is determined to be available, the walker can traverse to the next component (e.g., corresponding to the next node) and again capture state, node identity, time, and/or other information. It should be understood that this example embodiment is illustrative, and therefore should not be construed as being limiting in any way.

The walker can determine if criteria (for the modeling) have been met. In some embodiments, criteria can be specified for the network foundation model creation and the walker can determine if the criteria have been met. If the criteria have not been met, the walker can again determine edge weights and a next node can be determined. Thus, the modeling can continue until the walker determines that the criteria have been met. If the walker determines that the criteria have been met, the walker can output the determined sequence from the walker. Multiple sequences can be created for the network and/or a portion thereof by one or more walkers, which can be instantiated at any time. The sequences can be added to a dataset, and the network management service can train the network foundation model on the dataset. It should be understood that this example embodiment is illustrative, and therefore should not be construed as being limiting in any way.

Hypothetical scenarios can be fed to the network foundation model. For example, model input can be received (for example, from the user device) and the model input can be fed to the network foundation model. The network foundation model can process the model input to create output and the network management service can provide the model output to the user device or other device that created the model input. A command can be received by the network management service, with the command corresponding to instructions based on the model output (e.g., selections or input created at the user device and/or the like). The network management service can receive the command and generate a network command. The network management service can send the network command to the network controller, and based on the network command, the network controller can manage the network (e.g., implement changes to the network or a portion thereof). It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

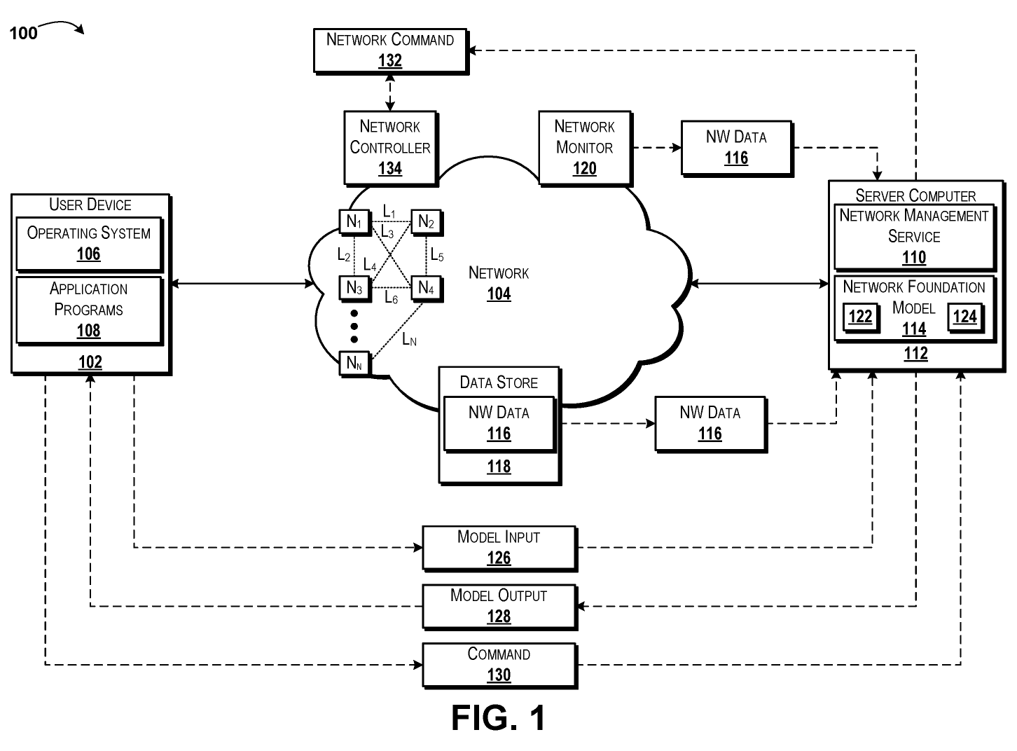

Referring now to FIG. 1, aspects of an operating environment 100 for various embodiments of the concepts and technologies disclosed herein for network management using a network foundation model will be described, according to an illustrative embodiment. The operating environment 100 shown in FIG. 1 includes a user device 102. The user device 102 can operate in communication with and/or as part of a communications network (“network”) 104, though this is not necessarily the case in all embodiments. According to various embodiments of the concepts and technologies disclosed herein, the user device 102 can be associated with a user such as a network operator, or the like, and can interact with other entities illustrated and described herein to create a model of the network 104 and/or other networks, and/or to provide network management using a model of the network 104 and/or other networks. It should be understood that this example embodiment is illustrative, and therefore should not be construed as being limiting in any way.

According to various embodiments, the functionality of the user device 102 may be provided by one or more desktop computers, mobile telephones, laptop computers, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a personal computer. It should be understood that this embodiment is illustrative, and should not be construed as being limiting in any way.

The user device 102 can execute an operating system 106 and one or more application programs 108 such as, for example, a web browser, a web application, a standalone or native application, a mobile application, combinations thereof, or the like. The operating system 106 can include a computer program that can control the operation of the user device 102. The application programs 108 can include executable programs that can be configured to execute on top of the operating system 106 to provide various functions as illustrated and described herein for interacting with a network management service 110 and/or other entities to manage a network 104 or portion thereof. According to various embodiments of the concepts and technologies disclosed herein, the application programs 108 can enable interactions with the network management service 110 via a portal, a web page, other communications (e.g., operations and/or commands via a mobile application on the user device 102 and an application that functions as the network management service 110), service calls and/or commands via an application programming interface (“API”), combinations thereof, or the like. Because the application programs 108 can be configured to interact with the network management service 110 in additional and/or alternative manners, it should be understood that these example embodiments are illustrative, and therefore should not be construed as being limiting in any way.

The network management service 110 can include a program, module, service, application, or the like, and can be hosted and/or executed by a computing device such as a server computer 112. According to various embodiments, the functionality of the server computer 112 may be provided by one or more server computers, application servers, web servers, desktop computers, laptop computers, other computing systems, and the like. It should be understood that the functionality of the server computer 112 may be provided by a single device, by two or more similar devices, and/or by two or more dissimilar devices. For purposes of describing the concepts and technologies disclosed herein, the server computer 112 is described herein as an application server. It should be understood that this embodiment is illustrative, and should not be construed as being limiting in any way.

According to various embodiments of the concepts and technologies disclosed herein, the network management service 110 can be configured to create, train, modify, and/or maintain a network foundation model 114. According to various embodiments of the concepts and technologies disclosed herein, the network management service 110 can include a generative artificial intelligence (“AI”) module that can create a probabilistic model of the network 104, which will be described in more detail herein as the network foundation model 114. The network foundation model 114 can be created to model a network such as the network 104 and/or a portion thereof. As is generally understood, a network 104 can include any number of network nodes (e.g., the network nodes N₁, N₂, … Nₙ shown in FIG. 1, which are collectively and/or generically referred to herein as network nodes N). Some or all of the network nodes N can be configured to communicate with one or more other network nodes N via communication links (L₁, L₂, … Lₙ shown in FIG. 1, which are collectively and/or generically referred to herein as communication links L). In addition to modeling the architecture and/or topology of the network 104 and/or a portion thereof, the network foundation model 114 can model states, changes, interactions, and the like among the network nodes N and/or communication links L. These and/or other aspects of the network foundation model 114 are illustrated and described in more detail herein.

As will be illustrated and described herein, the network foundation model 114 can include a generative AI probabilistic model of the network 104 and/or a portion thereof. The network foundation model 114 can model statistical relationships between components, events, operations, and traffic on the network 104, combined with natural language description and schematic representation of these aspects of the network 104. The network foundation model 114 can represent collective technical expertise within the networking industry and knowledge about the network 104. The network foundation model 114 can be used to answer questions about the network 104, solving planning tasks for the network 104, and supporting management of the network 104 by using vast data sources and repositories of information about the network 104. A network foundation model 114 can be trained over a large collection of datasets and documents in an unsupervised or semi-supervised way to support different applications related to the network 104. The network foundation model 114 can be used to generate content that would assist network operators, network planners, and/or others by providing technical knowledge, consultation, generating situation assessments of network health, and predicting service performance based on network information. The network foundation model 114 can also be used for recommending actions, to support network planning and network operations, as will be illustrated and described herein. It should be understood that this example embodiment is illustrative, and therefore should not be construed as being limiting in any way.

The network foundation model 114 can be trained on a variety of data sources, including textual documents, schematic figures, and information about the network 104 to generate a multimodal deep neural network that can model the network 104. The network management service 110 can be configured to access various sources of data (e.g., data from monitors of network events, measurements, statistics, and the like) to update and fine-tune the network foundation model 114. In the learning process, tools like machine learning models (e.g., Transformers) and recurrent neural networks (“RNN”) may process the information. Texts can be given as a sequence of words as they may be naturally sequential. Images may be processed as a sequence of pixels. Such sequential information can be collected and used to create the network foundation model 114 illustrated and described herein. Furthermore, information about the network, effects of network components on one another, and changes of component states can be collected by a walker as sequences of states. The sequences can be collected in a stochastic manner (or other manner in some embodiments) to represent a large variety of statistical connection in the network. It should be understood that this example embodiment is illustrative, and therefore should not be construed as being limiting in any way.

Once created, the network foundation model 114 can be used to answer complex queries about the network 104. For example, queries about the state of the network 104 at different times, components of the network 104, hypothetical scenarios related to the network 104, or the like can be answered using the network foundation model 114. In some embodiments, the network foundation model 114 can support retrieval augmented generation (“RAG”), where information can be retrieved from an authoritative data source and formulated as an answer or a summary, and generation of a statistically feasible network status for a hypothetical scenario, like the generation of text or an image for a given description. These and other modes of using the network foundation model 114 can complement each other to support a large variety of questions about the network 104. For example, a question like “what is the current load on the spine servers (L3 servers) in data center X?” may be translated by the network foundation model 114 into a query over a data source or a monitoring system with the information about spine servers in data center X, and the result can be transformed into a textual answer that the network operators can learn from about the status of these switches. A question such as “what is the effect of increasing by ten percent the load on switch S in data center X?” may be a hypothetical scenario for which the network foundation model 114 may generate a system state to answer the question. In any event, the questions can be formatted as input to the network foundation model 114 and an answer can be derived from output from the network foundation model 114. It should be understood that this example embodiment is illustrative, and therefore should not be construed as being limiting in any way.

According to various embodiments, the network management service 110 can be configured to create the network foundation model 114 based on information obtained from one or more data sources, as will be explained herein. In various embodiments of the concepts and technologies disclosed herein, the network management service 110 can be configured to begin a process for creating the network foundation model 114 in response to detecting a request for a network foundation model 114. The request can include, for example, an explicit request to create the network foundation model 114, a command to create the network foundation model 114, an implicit request (e.g., a request to modify some aspect of the network 104, or the like) to create the network foundation model 114, a service call application call to create the network foundation model 114, combinations thereof, or the like. Regardless of what prompts the network management service 110, the network management service 110 can be configured to generate the network foundation model 114. It should be understood that this example embodiment is illustrative, and therefore should not be construed as being limiting in any way.

In some embodiments, the network management service 110 can be configured to obtain network data 116 that describes the network 104 and/or a portion thereof in response to the request to create the network foundation model 114 (and/or at other times and/or under other circumstances). The network data 116 can describe, for example, an architecture of the network 104 and/or a portion thereof, one or more nodes N operating on the network 104 and/or a portion thereof, one or more communication links L associated with the network 104 and/or a portion thereof, and/or other information about the network 104 and/or a portion thereof.

In some embodiments, the network data 116 can be obtained from a server or data storage device such as, for example, a data store 118, a network monitor 120, and/or other devices and/or entities. In some embodiments, the functionality of the data store 118 can be provided by one or more databases, server computers, desktop computers, data storage resources, other computing systems, and the like. In some embodiments, the functionality of the network monitor 120 can be provided by one or more network reporting mechanisms, network event and/or message streams and/or event or message publishers, and/or other monitoring devices or entities as is generally understood. In the illustrated embodiments, the functionality of the data store 118 is described as being provided by a data server, and the network monitor 120 is described as being provided by a network monitoring entity that can create netflow data and/or other data describing entities and events on the network 104 and/or a portion thereof. It should be understood that this example embodiment is illustrative, and therefore should not be construed as being limiting in any way.

According to some embodiments, the network data 116 can include a data file and/or data structure that can define one or more connections such as the communication links L between components of the network 104 such as the nodes N. According to various embodiments, the network data 116 can define the entities such as the nodes N and the links such as the communication links L for wired and wireless portions of the network 104. Thus, the network data 116 can describe one or more components such as, for example, user equipment (“UEs”) and/or user devices, routers, switches, servers, antennas, base stations (e.g., eNodeBs, gNodeBs, and the like), mobility management entities (MMEs), gateways (SGW, PGW, ePDG), one or more interfaces, servers, resources, and the like; one or more events among and/or between the components; traffic among and/or between the components; links among and/or between the components; combinations thereof; or the like. It should be understood that this example embodiment is illustrative, and therefore should not be construed as being limiting in any way.

The network management service 110 can be configured to create, based on the network data 116, a network topology 122 and a network-flow model 124, which will be included in and/or can provide the basis of the network foundation model 114 in some embodiments. In some embodiments, the network topology 122 can include and/or can be formed as a graph (e.g., a directed graph). It should be understood that this example embodiment is illustrative, and therefore should not be construed as being limiting in any way. In some embodiments, the network topology 122 can be provided as a graph, where the components of the graph can correspond to the nodes N of the network 104, and where the connections between the components such as the nodes N (e.g., the communication links L) can correspond to the edges of the graph. It should be understood that this example embodiment is illustrative, and therefore should not be construed as being limiting in any way.

According to various embodiments of the concepts and technologies disclosed herein, the network management service 110 can be configured to create the edges of the graph (e.g., the communication links L) with associated weights that can indicate strengths of the connections (e.g., how often the communication links L represented by the edges are used and/or accessed by the nodes N represented by the components). In some embodiments, weights can also be equal, randomly sampled, or proportional/inversely proportional to other properties of the nodes and/or connection to promote different probability of traversal. The edges (e.g., the communication links L) and/or the weights associated therewith can be determined by the network management service 110 when creating the network foundation model 114 as illustrated and described herein based on the network data 116. As noted above, the network foundation model (e.g., a graph) can model a local area network (LAN), a wide area network (WAN), other networks and/or portions thereof such as the network 104, and the like, with the network foundation model 114 representing the components of the network, connections between them, and flows and/or operations performed by and/or among the components. Because other representations of the network 104 and/or portions thereof can provide the functionality of the network foundation model 114 illustrated and described herein (and/or the network topology 122 and/or network-flow model 124), it should be understood that the above example embodiment is illustrative, and therefore should not be construed as being limiting in any way.

According to various embodiments of the concepts and technologies disclosed herein, the network-flow model 124 can represent traffic of packets in the network 104 (e.g., actual traffic flow in the network 104), in a generalized, aggregated, and/or statistical manner. The network-flow model 124 therefore can model the amount(s) and/or type(s) of data that can be transferred between connected nodes N of the network 104, correlations between traffic patterns in nodes N and edges (e.g., the communication links L), and statistical probabilities of traffic flows and/or routes of packets in the network 104. The network-flow model 124 can be used to consider hypothetical network impact scenarios such as, for example, power outages, natural disasters, and the like, thereby gathering insight into the effects of a given traffic pattern (e.g., congestion) on a network edge. Thus, it can be appreciated that the network-flow model 124 can enable examination of how and/or what parts of the network 104 could be affected by a particular traffic pattern, how nodes N may affect one another under certain network conditions, combinations thereof, or the like. It should be understood that this example embodiment is illustrative, and therefore should not be construed as being limiting in any way.

According to various embodiments of the concepts and technologies disclosed herein, the creation of the network foundation model 114 can include identifying the nodes N of the network 104 and/or a portion thereof. The network management service 110 can also be configured to define, for each of the nodes N identified, states for those nodes N (e.g., what states are possible for those nodes N at any time). Additionally, the network management service 110 can be configured to identify the communication links L between the nodes N, and to define for those communication links L the possible states. Once the nodes N are identified, the network management service 110 can be configured to create one or more sequences that can represent traffic flows through the network 104 and/or a portion thereof (e.g., among and/or between one or more nodes N and via one or more communication links L). It should be understood that this example embodiment is illustrative, and therefore should not be construed as being limiting in any way.

In some embodiments, the sequences can represent an effect of nodes N on other nodes N. Sequences can include, for example, a sequence of states in a single node N. For a given sequence of length n and a node in the network, the local state of the node is measured periodically (e.g., every one hundred milliseconds, every second, or the like) until some number of states have been measured. This approach can yield a sequence that can be used for training the network foundation model 114 on predicting changes in nodes N. This can be applied to different nodes N at different times. It should be understood that this example embodiment is illustrative, and therefore should not be construed as being limiting in any way.

In some embodiments, the sequences can represent states on a route (e.g., a communication link L) between two or more nodes N. In particular, for a source node N and a target node N on the network 104, the route between them (e.g., a communication link L) can be discovered. For example, the route can be discovered using a command like tracert (traceroute) and this can provide the sequence of nodes N that handle the traffic between the source node N and the target node N. The states of the nodes N on the route can be recorded to create a sequence of states that models the travel of traffic (e.g., IP packets) from the source node N to the target node N. This can be repeated for many pairs of nodes, at different times, to create many examples for training the network foundation model 114. It should be understood that this example embodiment is illustrative, and therefore should not be construed as being limiting in any way.

In some embodiments, the sequences can represent states in a cluster of two or more nodes N. Sequences can include, for example, a sequence of states in a cluster of machines. For connected nodes N in a cluster of machines in the network 104, states of the nodes N can be measured and combined, in some order (e.g., by ordering the nodes N based on their MAC address or IP address, or the like) to train the network foundation model 114 to generate local effects between neighboring nodes N. This can be executed for different clusters at different times. It should be understood that this example embodiment is illustrative, and therefore should not be construed as being limiting in any way.

In some embodiments, the sequences can represent states on a path created by randomly walking the network 104 (e.g., using a walker as illustrated and described herein). In particular, a sequence of states on a path created by a walker over the network 104 can be generated. A sequence of nodes N can be selected by choosing an arbitrary node N in the network 104 and then conducting a random walk of some number (e.g., one less than the number of nodes N) of steps. The states of the nodes N in this walk can be captured and combined to create a sequence used to train the network foundation model 114. At each node N during the walk, a next node N can be selected from the neighbors of the current node N. The next node N can be selected uniformly or in a weighted fashion. In some instances, as illustrated and described herein, the next node N can be selected based on a connection to the current node N that has a highest probability of being selected (e.g., a most-utilized connection). As noted above, the selection of the next node N can also be based on stochastic (as opposed to deterministic) considerations and/or approaches. As such, it should be understood that this example embodiment is illustrative, and therefore should not be construed as being limiting in any way. In any event, states of the nodes N on the walk can be combined to create a sequence for the training of the network foundation model 114. This approach can be applied to multiple walkers beginning at different starting nodes N and/or at different times to create different examples for the training. It should be understood that this example embodiment is illustrative, and therefore should not be construed as being limiting in any way.

The network foundation model 114 can be used predict and generate network status for a large variety of scenarios. The spatiotemporal information can include the hour, day of week and geographic location of the node, because traffic patterns could change according to the hour of the day, the day, and the location. This approach can be used to allow the network 104 to learn traffic patterns that depend on the time and the geographic location and general patterns that are not affected by time or geospatial location. The network foundation model 114 can predict the next state and its information, to generate sequences that represent likely effects of nodes N on neighboring nodes N and likely changes of states in a specific node N. The generated sequence can include states in a node N, states on a route between two nodes N, states of nodes N of a cluster of machines, and states on nodes N of a random walk on the network 104. When using transformers, the attention mechanism can improve the prediction of a state of a node N by focusing on the nodes N and states that affect the predicted state. For example, a state of a switch close to a data center could highly influence the state of an edge node N or a base station when there is a route with high-volume traffic between them. It should be understood that this example embodiment is illustrative, and therefore should not be construed as being limiting in any way.

In the walk example given above, the network management service 110 can create the sequences by selecting a node N. The node N can be selected randomly and/or based on some considerations and/or instructions. For example, a node N may be selected based on instructions that specify selecting the node N in order to create a sequence for a particular part of the network 104 and/or a portion thereof, for a particular node N, for a particular communication link L, or the like. It should be understood that this example embodiment is illustrative, and therefore should not be construed as being limiting in any way.

Regardless of how the node N is selected, a walker can be placed on the selected node N (e.g., the walker can be placed on a component of the directed graph that corresponds to the network topology 122 in some embodiments). The walker can include a probe or other software code that can be configured to traverse the directed graph that represents the network 104 and/or a portion thereof in a manner that is similar to the manner in which traffic flows across the network 104 and/or a portion thereof. In various embodiments of the concepts and technologies disclosed herein, the walker can be provided by code and/or processes included in the network management service 110, though this is not necessarily the case in all embodiments. In various embodiments, the walker can be configured to capture state, node identity, time, and/or other information as it traverses the directed graph that represents the network 104 and/or a portion thereof, as well as being configured to determine a path to take when traversing the directed graph that represents the network 104 and/or a portion thereof. It should be understood that this example embodiment is illustrative, and therefore should not be construed as being limiting in any way.

In some embodiments, after capturing state, time, node identity, and/or other information, the walker can determine, at a selected node N (e.g., at a particular component that represents the node N), a weight for each edge that connects to the component, where the edges can correspond to and/or represent communication links L, and where the weights can represent an amount of traffic or utilization (with a highest weight representing a highest utilization and/or amount of traffic in various embodiments). According to various embodiments of the concepts and technologies disclosed herein, the walker can identify an edge having a highest weight and identify a next node (e.g., a next component on the directed graph) that is encountered along that edge. It should be understood that this example embodiment is illustrative, and therefore should not be construed as being limiting in any way.

The walker can determine if the next node (e.g., the next component) is available, or if the next node (e.g., component) has been removed, is inactive, or the like. If the next node is not available, the walker can again determine a next node (e.g., by finding the next highest weighted edge and an associated component next encountered along that edge). In some embodiments, selection of the next node N can be accomplished using a probabilistic process of randomly selecting the edge to traverse in a way that is proportional to the edge weights. Because the next node N can be identified or determined in additional and/or alternative manners, it should be understood that these example embodiments are illustrative, and therefore should not be construed as being limiting in any way. If the next node is determined to be available, the walker can traverse the determined edge and arrive at the next node (e.g., component on the directed graph) and capture state, time, node identity, and/or other information at that node. It should be understood that this example embodiment is illustrative, and therefore should not be construed as being limiting in any way.

The walker can determine if criteria (for the modeling) have been met. In particular, criteria can be specified for the network foundation model 114 creation such as a number of nodes N to traverse, a portion of the network 104 and/or a portion thereof that is to be modeled, a number of communication links L to be explored, a runtime for the modeling, combinations thereof, or the like. Thus, the walker can determine if the criteria have been met. If the criteria have not been met, the walker can again determine edge weights and a next node N can be determined. Thus, the modeling can continue until the walker determines that the criteria have been met. If the walker determines that the criteria have been met, the walker can output the determined sequences (e.g., [node 1, state 1; node 2, state 2; node 3, state 3; …; node N, state N], or the like). It should be understood that this example embodiment is illustrative, and therefore should not be construed as being limiting in any way.

Multiple sequences can be created for the network 104 and/or a portion thereof. In some embodiments, multiple walkers can be instantiated at any time, and the network foundation model 114 can be based on one or more sequence generated thereby. The sequences can be added to a dataset, and the network management service 110 can train the network foundation model 114 on the dataset. Thus, it can be appreciated that the network foundation model 114 can be generated based on the sequences created by the walkers. It should be understood that this example embodiment is illustrative, and therefore should not be construed as being limiting in any way.

With the network foundation model 114 created and trained, one or more hypothetical scenarios can be fed to the network foundation model 114 to test network response to various events. Network management decisions may be based on output from the network foundation model 114 in some embodiments. In some embodiments, for example, model input 126 can be received (for example, from the user device 102). The model input 126 can be fed to the network foundation model 114 and the network foundation model 114 can process the model input 126 to create output. The network management service 110 can provide the model output 128 to the user device 102 or other device that created the model input 126. A command 130 can be received by the network management service 110, with the command 130 corresponding to instructions based on the model output 128. For example, if the model input 126 tests a network response to a power outage and the model output 128 indicates what the network response would be, a user or other entity may create a command 130 for instructing the network 104 to modify operation of some node N to plan for a power outage. It should be understood that this example embodiment is illustrative, and therefore should not be construed as being limiting in any way.

The network management service 110 can receive the command 130 and generate a network command 132 that can include computer-executable instructions that, when received by a network device such as the network controller 134, cause the network device (e.g., the network controller 134) to modify the network 104 as indicated by the command 130. The network management service 110 can send the network command 132 to the network controller 134 for managing the network 104 or a portion thereof. It should be understood that this example embodiment is illustrative, and therefore should not be construed as being limiting in any way.

In practice, a network management service 110 can be hosted and/or executed by a device or resource such as a server computer 112. The network management service 110 can be configured to detect a request to create a network foundation model 114, which can model entities (e.g., nodes N, communication links L, and the like) on a network 104 and/or a portion thereof, as well as traffic flows and/or patterns across the network 104 and/or a portion thereof. The network foundation model 114 can include and/or can be based on a network topology 122 and a network-flow model 124 in some embodiments. It should be understood that this example embodiment is illustrative, and therefore should not be construed as being limiting in any way.

The network management service 110 can obtain, from a data store 118, a network monitor 120, and/or other sources, a network data 116 that can describe the network 104, entities such as nodes N operating on the network 104, communication links L between the nodes N, events occurring on the network 104, traffic flows and/or patterns on the network 104, other aspects of the network 104, combinations thereof, or the like. The network management service 110 can create, based on the network data 116, a network topology 122 (e.g., a direct graph including components that represent the nodes N and edges that represent the communication links L) and a network-flow model 124 that represents traffic flows and/or events on the network 104. The network management service 110 can define possible states for the nodes N and the communication links L, and perform a process to collect state for the nodes N. It should be understood that this example embodiment is illustrative, and therefore should not be construed as being limiting in any way.

To collect the state for the nodes N, the network management service 110 can locate a walker (e.g., a software probe, a process run by the network management service 110, or the like) on a component of the directed graph that corresponds to a node N. The node N can be selected at random, based on instructions, based on other considerations, or the like. The walker can capture state, node identity, time, other information, and the like for the node. The walker can then identify weights for edges that connect to the component, with the edges corresponding to the communication links L that connect to the node N. A next component can be determined (with the next component corresponding to the next node N) based on the weights. In some embodiments, the edge with the highest weight (e.g., corresponding to a highest utilization, a highest probability that traffic will flow via that edge, or the like) can be identified based on the weights and a next component on that edge can be determined. If the next component is not available, a new next component can be identified (e.g., along the edge having the next highest weight, or the like). Once a next component that is identified is determined to be available, the walker can traverse to the next component (e.g., corresponding to the next node N) and again capture state, node identity, time, and/or other information. It should be understood that this example embodiment is illustrative, and therefore should not be construed as being limiting in any way.

The walker can determine if criteria (for the modeling) have been met. In some embodiments, criteria can be specified for the network foundation model 114 creation and the walker can determine if the criteria have been met. If the criteria have not been met, the walker can again determine edge weights and a next node N can be determined. Thus, the modeling can continue until the walker determines that the criteria have been met. If the walker determines that the criteria have been met, the walker can output the determined sequence from the walker. Multiple sequences can be created for the network 104 and/or a portion thereof by one or more walkers, which can be instantiated at any time. The sequences can be added to a dataset, and the network management service 110 can train the network foundation model 114 on the dataset. It should be understood that this example embodiment is illustrative, and therefore should not be construed as being limiting in any way.

Hypothetical scenarios can be fed to the network foundation model 114. For example, model input 126 can be received (for example, from the user device 102) and the model input 126 can be fed to the network foundation model 114. The network foundation model 114 can process the model input 126 to create output and the network management service 110 can provide the model output 128 to the user device 102 or other device that created the model input 126. A command 130 can be received by the network management service 110, with the command 130 corresponding to instructions based on the model output 128 (e.g., selections or input created at the user device 102 and/or the like). The network management service 110 can receive the command 130 and generate a network command 132. The network management service 110 can send the network command 132 to the network controller 134, and based on the network command 132, the network controller 134 can manage the network 104 (e.g., implement changes to the network 104 or a portion thereof). It should be understood that this example embodiment is illustrative, and therefore should not be construed as being limiting in any way.

FIG. 1 illustrates one user device 102, one network 104, one server computer 112, one data store 118, one network monitor 120, and one network controller 134. It should be understood, however, that various implementations of the operating environment 100 can include zero, one, or more than one user device 102; one or more than one network 104; one or more than one server computer 112; zero, one, or more than one data store 118; zero, one, or more than one network monitor 120; and/or zero, one, or more than one network controller 134. As such, the illustrated embodiment should be understood as being illustrative, and should not be construed as being limiting in any way.

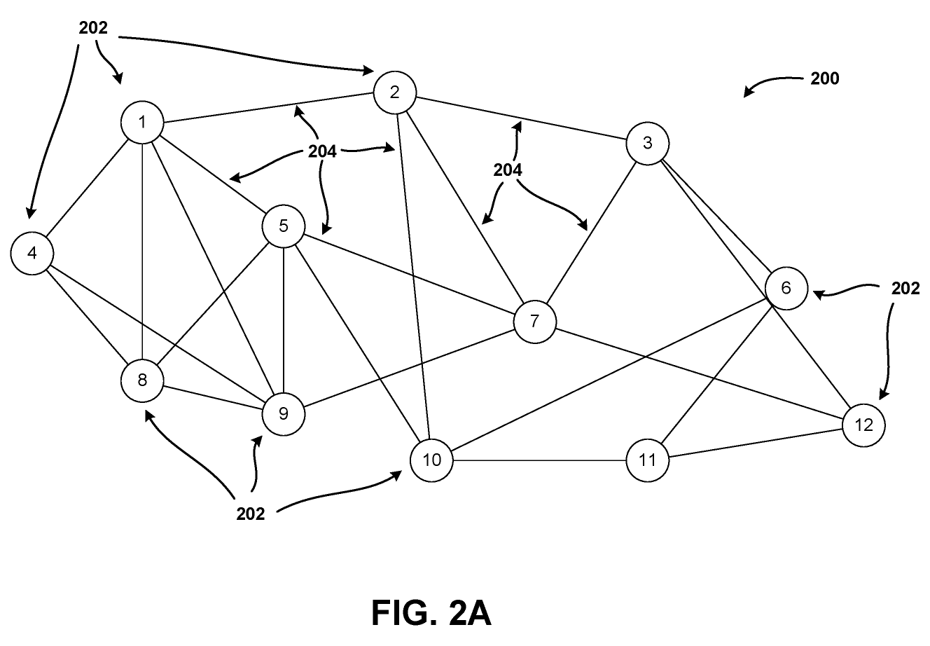

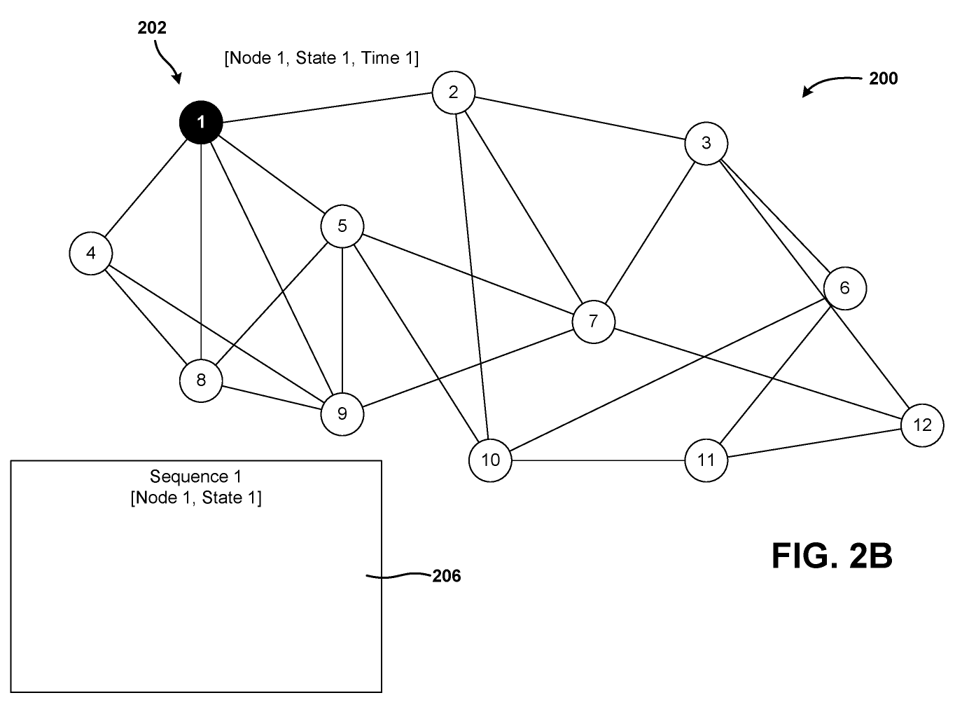

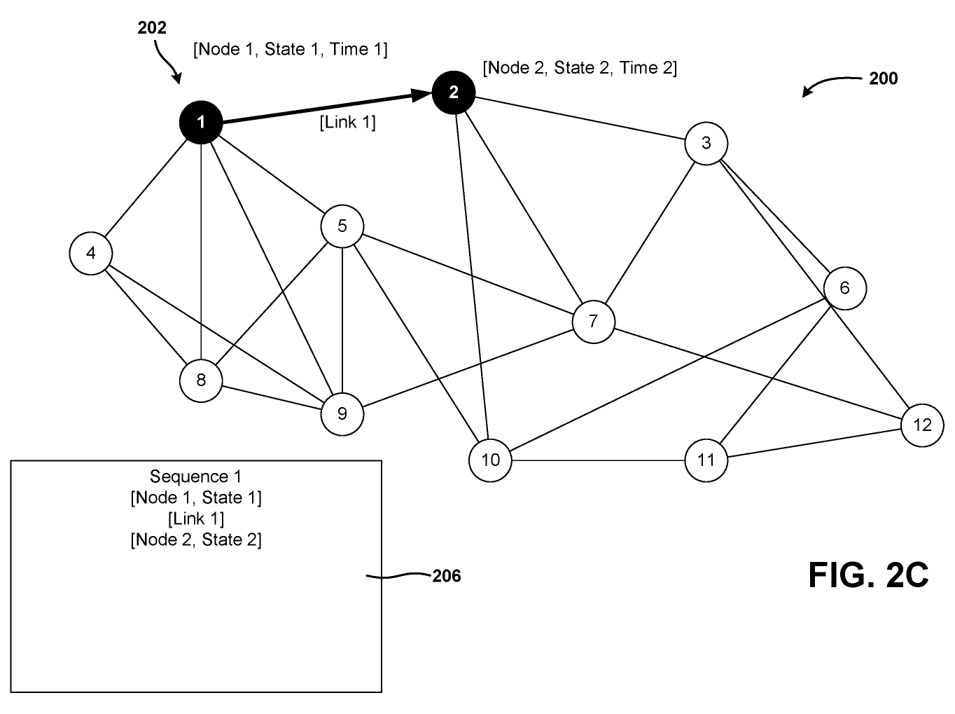

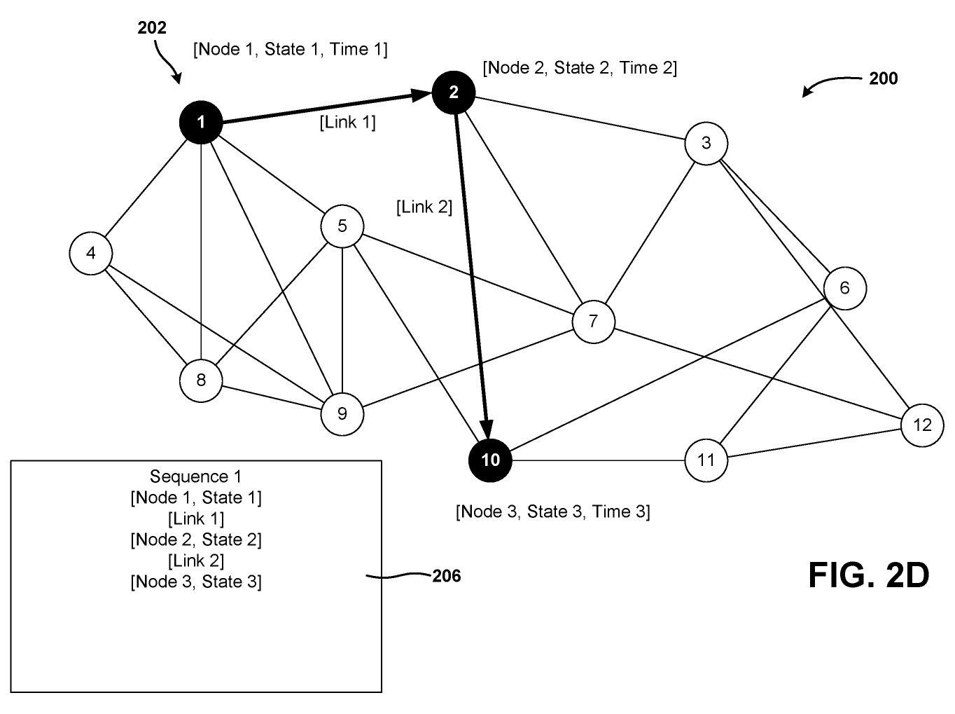

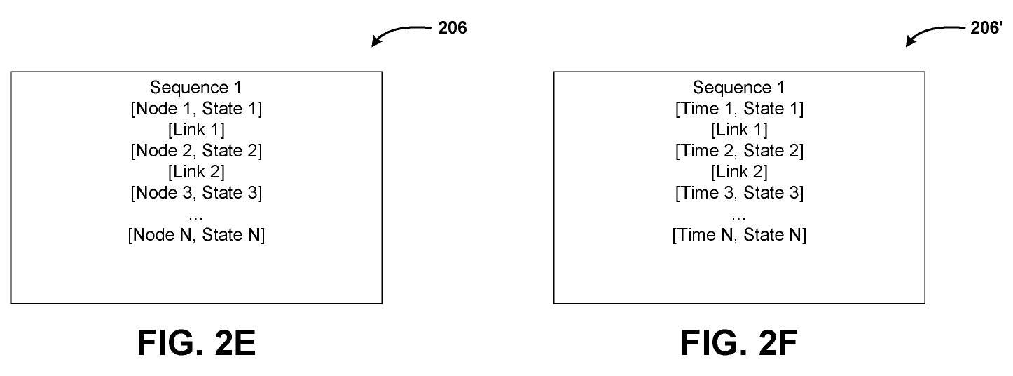

Turning to FIG. 2A, an example directed graph 200 is illustrated, according to an example embodiment of the concepts and technologies disclosed herein. It can be appreciated from the description herein that the directed graph 200 can be one example of a network topology 122 illustrated and described herein. It should be understood that this example embodiment is illustrative, and therefore should not be construed as being limiting in any way.

As shown in FIG. 2A, the directed graph 200 can include any number of components 202, which can correspond to the nodes N illustrated and described herein. The components 202 can be connected to one or more other components 202 by one or more edges 204. It can be appreciated that the edges 204 can correspond to the communication links L illustrated and described herein. It should be understood that this example embodiment is illustrative, and therefore should not be construed as being limiting in any way.

With reference to FIG. 2A, it can be appreciated that some components 202 may be connected to any number of other components 202, but that all components 202 need not be connected to all other components 202 directly. It further can be appreciated that all components 202 can be connected to at least one other component 202 according to various embodiments of the concepts and technologies disclosed herein. It should be understood that this example embodiment is illustrative, and therefore should not be construed as being limiting in any way.

Although not visible in FIG. 2A, it should be understood that each edge 204 can have an associated weight. Thus, for example, the edge 204 between a first of the components 202 (e.g., the component 202 that is labeled “1”) and a second of the components 202 (e.g., the component 202 that is labeled “2”) can have an associated weight that can represent an amount of traffic transmitted along a communication link L that corresponds to that edge 204. As such, the edges 204 can each include a weight that represents a likelihood that the edges 204 are accessed by a particular component 202. It should be understood that this example embodiment is illustrative, and therefore should not be construed as being limiting in any way.

Turning now to FIG. 2B, it can be appreciated that a component 202 can be selected. In the illustrated embodiment, the component 202 that is labeled “1” has been selected to begin calculation of a sequence 206. Thus, in FIG. 2B, the sequence 206 is being compiled and can include data representing the state of a node N at a particular time, e.g., [Node 1, State 1, Time 1]. It should be understood that this example embodiment is illustrative, and therefore should not be construed as being limiting in any way.

In various embodiments of the concepts and technologies disclosed herein, a walker can be located at the selected component 202 (e.g., a node N). The walker can correspond to a probe, or the like, which can traverse the directed graph 200 and determine, at each component 202 (e.g., node N) and/or edge 204 (e.g., communication link L) a state, time, and/or other information. It should be understood that this example embodiment is illustrative, and therefore should not be construed as being limiting in any way.

In FIG. 2B, a sequence 206 is being compiled by the walker. The sequence 206 can include data representing the state of a node N, e.g., [Node 1, State 1]. Although time also can be captured, it should be understood that the sequence 206 may not include the time unless that is specified as will be illustrated and described herein. It should be understood that this example embodiment is illustrative, and therefore should not be construed as being limiting in any way.

Turning now to FIG. 2C, it can be appreciated that a next portion of the sequence 206 can be determined by the walker based on any edges 204 that connect to the component 202 last selected. In particular, each edge 204 that connects to the component 202 selected previously (in the illustrated example, the component 202 labeled “1”) can have an associated weight that can represent a likelihood that traffic at the component 202 would proceed along the associated edge 204. In the example illustrated in FIG. 2C, the edge 204 between the component 202 labeled “1” and the component 202 labeled “2” can have a highest weight, e.g., may be determined to be the most likely path for traffic progressing from the component 202 labeled “1.” Thus, the walker can progress along that edge 204. It should be understood that this example embodiment is illustrative, and therefore should not be construed as being limiting in any way.

In FIG. 2C, the sequence 206 that is being compiled has been updated by the walker to include data representing the state of another node N at another particular time, e.g., [Node 2, State 2, Time 2], and that the traffic progressed from the component 202 labeled “1” to the component 202 labeled “2” along the edge 204 labeled “Link 1.” Thus, the sequence 206 now includes three events and their associated states (e.g., [Node 1, State 1], [Link 1], and [Node 2, State 2]). Although time also can be captured, it should be understood that the sequence 206 may not include the time unless that is specified as will be illustrated and described herein. It should be understood that this example embodiment is illustrative, and therefore should not be construed as being limiting in any way.

Turning now to FIG. 2D, it can be appreciated that a next portion of the sequence 206 can be determined by the walker based on any edges 204 that connect to the component 202 last selected. In particular, each edge 204 that connects to the component 202 selected last (in the illustrated example, the component 202 labeled “2”) can have an associated weight that can represent a likelihood that traffic at the component 202 would proceed along the associated edge 204. In the example illustrated in FIG. 2D, the edge 204 between the component 202 labeled “2” and the component 202 labeled “10” can have a highest weight, e.g., may be determined to be the most likely path for traffic progressing from the component 202 labeled “2.” It should be understood that this example embodiment is illustrative, and therefore should not be construed as being limiting in any way.

Thus, in FIG. 2D, the sequence 206 that is being compiled has been updated to include data representing the state of another node N at another particular time, e.g., [Node 3, State 3], and that the traffic progressed from the component 202 labeled “2” to the component 202 labeled “10” along the edge 204 labeled “Link 2.” Thus, the sequence 206 now includes five events and their associated states (e.g., [Node 1, State 1], [Link 1], [Node 2, State 2], [Link 2], and [Node 3, State 3]). It should be understood that this example embodiment is illustrative, and therefore should not be construed as being limiting in any way. Although not illustrated herein, it can be appreciated that these operations can be repeated for all components 202 and/or until a network 104 and/or a portion thereof is satisfactorily modeled. Thus, as shown in FIG. 2E, a sequence 206 can include any number of events such as, for example, [Node 1, State 1], [Link 1], [Node 2, State 2], [Link 2], [Node 3, State 3], …, and [Node N, State N]. It should be understood that this example embodiment is illustrative, and therefore should not be construed as being limiting in any way.

Turning now to FIG. 2F, it should be understood that embodiments of the concepts and technologies disclosed herein can enable reordering and/or re-sequencing traffic flows associated with the network 104 and/or a portion thereof based on time or other factors, including but not limited to physical locations, network component type, etc. Thus, as shown in FIG. 2F, a modified sequence 206' can include the states ordered based on time (instead of being based on node N or component 202). Thus, the modified sequence 206' can be expressed as, [Time 1, State 1], [Link 1], [Time 2, State 2], [Link 2], [Time 3, State 3], …, and [Time N, State N]. It should be understood that this example embodiment is illustrative, and therefore should not be construed as being limiting in any way.

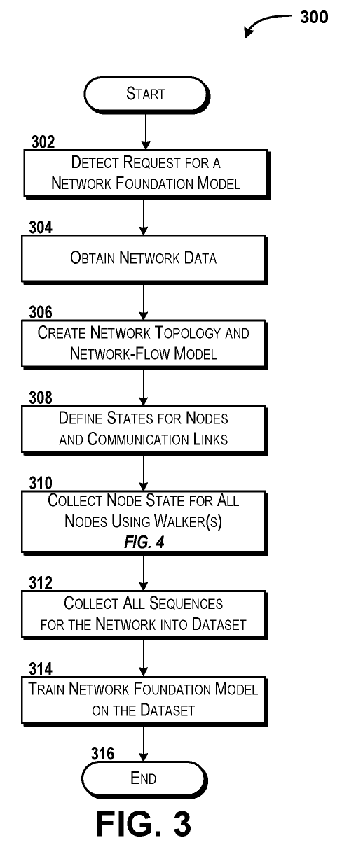

Turning now to FIG. 3, aspects of a method 300 for creating or updating a network foundation model will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the server computer 112, to perform one or more operations and/or causing the processor to direct other components of the computing system or device to perform one or more of the operations.

For purposes of illustrating and describing the concepts of the present disclosure, the methods illustrated and described herein are described as being performed by the server computer 112 via execution of one or more software modules such as, for example, the network management service 110. It should be understood that additional and/or alternative devices and/or network nodes can provide the functionality described herein via execution of one or more modules, applications, and/or other software including, but not limited to, the network management service 110. Thus, the illustrated embodiments are illustrative, and should not be viewed as being limiting in any way.

The method 300 begins at operation 302. At operation 302, the server computer 112 can detect a request for a network foundation model 114. The network foundation model 114 requested in operation 302 can be requested to model a network, for example, the network 104 illustrated and described herein. According to various embodiments of the concepts and technologies disclosed herein, the request to create the network foundation model 114 in operation 302 can include an explicit request such as a service call (to create the network foundation model 114), a command (to create the network foundation model 114), or other request or command. In some other embodiments, the request to create the network foundation model 114 can include an implicit request such as a setting or configuration that causes the network management service 110 to create the network foundation model 114 on startup, activation, or the like; a need for the network foundation model 114, or the like. Because the request to create the network foundation model 114 can be detected in additional and/or alternative manners, it should be understood that these example embodiments are illustrative, and therefore should not be construed as being limiting in any way.

From operation 302, the method 300 can proceed to operation 304. At operation 304, the server computer 112 can obtain network data 116. The network data 116 obtained in operation 304 can describe the network architecture and/or topology for the network 104 (or other network for which the network foundation model 114 is requested in operation 302). In some embodiments, the network data 116 can include event logs, netflow data, network architecture data, network topology information, combinations thereof, or the like. Thus, in operation 304, the server computer 112 can obtain information describing the network 104 and/or a portion thereof, nodes N and/or communication links L associated with the network 104 and/or a portion thereof, states and/or event information associated with the nodes N and/or communication links L, combinations thereof, or the like.

From operation 304, the method 300 can proceed to operation 306. At operation 306, the server computer 112 can generate a network topology 122 and a network-flow model 124 based on the network data 116. As explained herein, the network topology 122 can be created by the server computer 112 (via execution of the network management service 110) based on the network data 116 and can be created, in some embodiments, as a graph such as a directed graph. In some embodiments, a directed graph can include nodes N (as the components of the directed graph) and communication links L (as the edges of the directed graph). It should be understood that this example embodiment is illustrative, and therefore should not be construed as being limiting in any way.

According to various embodiments of the concepts and technologies disclosed herein, the network topology 122 can be determined by discovering the nodes N and communication links L between the nodes N. In some embodiments, this discovering can be accomplished using protocols such as, for example, link layer discovery protocol (“LLDP”), Cisco discovery protocols (“CDP”), tools such as LLDPTOOL, or the like. The discovery can be executed on known network nodes N to find neighbors of those nodes N and/or to traverse a determined graph (describing the topology), and the graph can be used (by using graph traversal) to reveal and model the network topology 122. It can be appreciated that embodiments of the concepts and technologies disclosed herein can include periodically and/or on-demand updating of the network topology 122 as will be illustrated and described in more detail herein. It should be understood that this example embodiment is illustrative, and therefore should not be construed as being limiting in any way.

The network-flow model 124 can represent data communications occurring in the network 104 and/or a portion thereof. Thus, the network-flow model 124 can model data transfers among and/or between one or more nodes N of the network 104 and/or a portion thereof and/or along one or more communication links L. It should be understood that this example embodiment is illustrative, and therefore should not be construed as being limiting in any way. It can be appreciated that operation 306 can include the server computer 112 analyzing the network data 116 obtained in operation 304 and creating, based on the network data 116, the network topology 122 and the network-flow model 124. It should be understood that this example embodiment is illustrative, and therefore should not be construed as being limiting in any way.

From operation 306, the method 300 can proceed to operation 308. At operation 308, the server computer 112 can define states for nodes of the network (e.g., the network 104) represented by the network data 116 obtained in operation 304. According to various embodiments of the concepts and technologies disclosed herein, the states (for nodes of the network 104 and/or a portion thereof) can be defined based on the type of element each node N is, capacities and/or capabilities of the communications links L, and the like. Examples of states include, but are not limited to, actual packets flowing through, performance/statistics such as throughput, latency, various sensor readings, etc. States can have multimodal format, including numeric, text (e.g., error messages, packets), or visual/audio (e.g., certain sensor capture). It should be understood that these examples embodiments are illustrative, and therefore should not be construed as being limiting in any way. At any rate, operation 308 can correspond to the server computer 112 defining possible states and/or possible values for the states for each component (e.g., node N and communication link L) on the network 104 and/or a portion thereof. It should be understood that this example embodiment is illustrative, and therefore should not be construed as being limiting in any way.

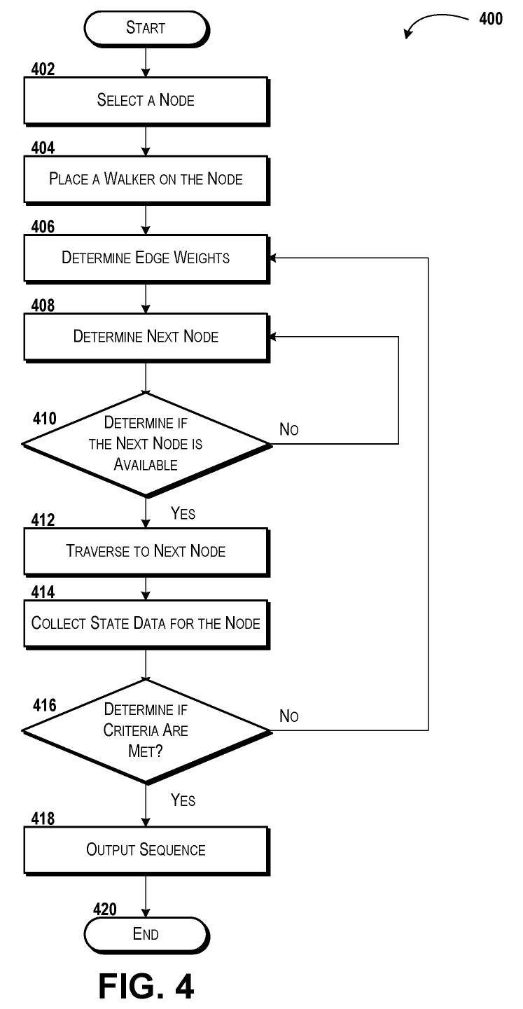

From operation 308, the method 300 can proceed to operation 310. At operation 310, the server computer 112 can collect state for all nodes of the network being modeled (e.g., the network 104) using one or more walkers. Additional details of how state is collected for all nodes N of the network 104 and/or a portion thereof being modeled will be illustrated and described in more detail herein with reference to FIG. 4. Briefly, however, the states can be created as discrete representations of the states of components and sub-components of the network 104 and/or a portion thereof (being modeled). By way of example, a state of an ingress queue of a particular node N such as a network switch could be monitored using in-band network telemetry (“INT”), for example, and the queue occupancy may be given a value. In some example embodiments, for example, the value may be associated with a predefined scale such as, for example, a scale of one to five with one corresponding to the queue being nearly empty and five corresponding to the queue being completely full. It should be understood that this example embodiment is illustrative, and therefore should not be construed as being limiting in any way.

By way of another example, state of an egress queues, memory usage, CPU utilization, or the like can be created. A tuple of the measured states of the components and/or subcomponents of a network 104 and/or a portion thereof can represent the state of the components (e.g., the switch in the above example). Similar tuples can be created for other components of the network 104 and/or a portion thereof such as, for example, routers, servers, gateways, base stations, etc. According to embodiments of the concepts and technologies disclosed herein, the result can include a state-representing tuple per component (e.g., a node N, a communication link L, or the like) at a given time. The language can be enriched, in some embodiments, by adding network states to vocabulary, thereby enabling the network 104 and/or a portion thereof being trained or fine-tuned on a set of tokens that can include tokens that represent these states and/or others. It should be understood that these example embodiments are illustrative, and therefore should not be construed as being limiting in any way.

From operation 310, the method 300 can proceed to operation 312. At operation 312, the server computer 112 can collect all sequences for the network (e.g., the network 104) into a dataset. As is illustrated and described herein, the server computer 112 can create a sequence (e.g., a node progression sequence, a time-based progression sequence, or other sequence) that describes traffic flow among and/or between the nodes N and/or along communication links L, as well as state at and/or along the nodes N and/or communication links L, with the sequence output being repeated for each sequence determined for the network 104 and/or a portion thereof being modeled. Thus, operation 312 can correspond to the collection of the sequences into a dataset. The collected sequences can be further processed by, for example, reordering by an attribute such as time, location, aggregation, clustering, summarization, up-sampling, down-sampling, concatenation, combinations thereof, or the like. It should be understood that this example embodiment is illustrative, and therefore should not be construed as being limiting in any way.

From operation 312, the method 300 can proceed to operation 314. At operation 314, the server computer 112 can train a network foundation model 114 on the dataset created in operation 310. In operation 314, the dataset created and/or obtained in operation 312 can be trained to create the network foundation model 114 illustrated and described herein. The network foundation model 114 can represent the network 104 and/or a portion thereof through any and/or all possible flows and/or conditions associated with the network 104 and/or a portion thereof, thereby enabling modeling of the network 104 and/or a portion thereof. The network foundation model 114 can be used to simulate operation of the network 104 and/or a portion thereof under various conditions. It should be understood that this example embodiment is illustrative, and therefore should not be construed as being limiting in any way.

From operation 314, the method 300 can proceed to operation 316. The method 300 can end at operation 316.

Turning now to FIG. 4, aspects of a method 400 for collecting state for nodes will be described in detail, according to an illustrative embodiment. It can be appreciated that operations of the method 400 can be performed, for example, in association with operation 310 illustrated and described above with reference to FIG. 3. Because the operations of the method 400 can be performed at additional and/or alternative times, it should be understood that this embodiment is illustrative, and therefore should not be construed as being limiting in any way.

The method 400 begins at operation 402. At operation 402, the server computer 112 can select a node N. According to various embodiments of the concepts and technologies disclosed herein, the server computer 112 can be configured to randomly select a node N from the network 104 and/or a portion thereof as represented by a network topology 122 and/or a directed graph 200 as illustrated and described herein. According to some other embodiments, instructions for selecting a node N can be defined for the server computer 112, for example to obtain state for particular nodes N, to traverse a particular portion of the network 104, or the like. Thus, operation 402 can correspond to the server computer 112 selecting a node N in any manner. It should be understood that this example embodiment is illustrative, and therefore should not be construed as being limiting in any way.

From operation 402, the method 400 can proceed to operation 404. At operation 404, the server computer 112 can place a walker on the node N selected in operation 402. The walker can correspond to a probe, or the like, which can be configured to determine for each node N, a state, a time, or the like. Thus, the walker can be located by the server computer 112 on the node N selected in operation 402 for purposes of traversing a portion of the network 104 being modeled based on a selected node N and weights associated with various communication links L that connect to the node N selected in operation 402. Based on the example shown in FIGS. 2A-2F, it can be appreciated that operation 404 can be performed by the server computer 112 by locating the walker on a particular component 202 of a directed graph 200, where the component 202 can correspond to a particular node N of the network 104, and that the edges 204 can correspond to the communication links L. It should be understood that this example embodiment is illustrative, and therefore should not be construed as being limiting in any way.

From operation 404, the method 400 can proceed to operation 406. At operation 406, the server computer 112 can determine edge weights, e.g., determine weights for each communication link L that connects the node N selected in operation 402 to another node N to and/or with which the node N selected in operation 402 communicates. Based on the example shown in FIGS. 2A-2F, it can be appreciated that operation 406 can be performed by the server computer 112 by determining, for each edge 204 that connects to the component 202 of the directed graph 200 at which the walker was placed in operation 404, an associated weight that defines a likelihood that traffic from the component 202 selected in operation 402 leaves the component 202 along that associated edge 204. Again, the component 202 can correspond to a particular node N of the network 104 and the edges 204 can correspond to communication links L that connect to that node N. It should be understood that this example embodiment is illustrative, and therefore should not be construed as being limiting in any way.

From operation 406, the method 400 can proceed to operation 408. At operation 408, the server computer 112 can determine a next node N to which the walker is to traverse. In various embodiments, the server computer 112 can determine the next node N in operation 408 based on the edge weights determined in operation 406. Thus, for example, the server computer 112 can determine a next node N by identifying, based on the edge weights determined in operation 406, the edge 204 (e.g., the communication link L) associated with the greatest-weighted edge and the node N to which that edge leads. It should be understood that this example embodiment is illustrative, and therefore should not be construed as being limiting in any way.

In some other embodiments, the edge weights may or may not be calculated, and the determination of the next node N may be based on other considerations such as, for example, a list of nodes N to be traversed, a specific traffic path or pattern along which the walker is to traverse the network 104, or other instructions or considerations to determine a next node N, etc. As such, it should be understood that the above example embodiment is illustrative, and therefore should not be construed as being limiting in any way.

From operation 408, the method 400 can proceed to operation 410. At operation 410, the server computer 112 can determine if the next node N (determined in operation 408) is available. In operation 410, the server computer 112 can determine, for example, if the next node N determined in operation 408 is still operating on the network 104, if the node N was removed from the network 104, if a communication link L leading to the node N is active and/or removed, or the like. Thus, operation 410 can correspond to any operations performed by the server computer 112 (and/or the walker) to determine if a determined next node N is still accessible to the walker. It should be understood that this example embodiment is illustrative, and therefore should not be construed as being limiting in any way.

If the server computer 112 determines, in operation 410, that the next node N determined in operation 408 is not available, the method 400 can return to operation 408, and the server computer 112 can again determine a next node N. It can be appreciated that the previously selected next node N can be removed from the pool of possible next nodes N in the second or subsequent iteration of operation 408 in some embodiments. It should be understood that this example embodiment is illustrative, and therefore should not be construed as being limiting in any way. It also can be appreciated that operations 408-410 can be iterated until the server computer 112 determines, in any iteration of operation 410, that the next node N determined in operation 408 is available.

If the server computer 112 determines, in any iteration of operation 410, that the next node N determined in operation 408 is available, the method 400 can proceed to operation 412. At operation 412, the server computer 112 can cause the walker to traverse to the next node N determined in operation 408. Thus, the walker can access the next node N via the edge 204 (or communication link L) determined to have the highest weight. It should be understood that this example embodiment is illustrative, and therefore should not be construed as being limiting in any way.

From operation 412, the method 400 can proceed to operation 414. At operation 414, the server computer 112 (e.g., via the walker) can collect state data for the node N to which the walker traversed in operation 412. Thus, the walker can capture, for example, information identifying the node N to which the walker traversed in operation 412, a state associated with the node N to which the walker traversed in operation 412, a time at which the state was captured for the node N by the walker, and/or other information associated with the node N, state, time, or the like. In some embodiments, this information can be saved and/or output by the walker for future use. It should be understood that this example embodiment is illustrative, and therefore should not be construed as being limiting in any way.

From operation 414, the method 400 can proceed to operation 416. At operation 416, the server computer 112 can determine if criteria (for the modeling) have been met. In some embodiments of the concepts and technologies disclosed herein, criteria for the modeling can be defined, for example, by settings, configurations, instructions, or the like. The criteria can define, for example, a number of nodes N that should be traversed by the walker during the state capturing, an amount of time for which the walker should traverse the network 104 during the state capturing, a number of states that should be captured during the state capturing, a percentage or share of the network 104 that should be traversed by the walker, or the like. Thus, operation 416 can correspond to the server computer 112 identifying the specified criteria for the traversing and state capturing, and determining if the specified criteria have been met. It should be understood that this example embodiment is illustrative, and therefore should not be construed as being limiting in any way.

If the server computer 112 determines, in operation 416, that the criteria for the modeling have not been met, the method 400 can return to operation 406, and the server computer 112 can again determine edge weights for the node N at which the walker is now located (e.g., the node N to which the walker traversed in a last iteration of operation 412). As such, it can be appreciated that operations 406-416 can be iterated until the server computer 112 determines, in any iteration of operation 416, that the criteria for the modeling have been met.

If the server computer 112 determines, in any iteration of operation 416, that the criteria for the modeling have been met, the method 400 can proceed to operation 418. At operation 418, the server computer 112 can output the sequence(s) generated in the one or more iterations of operation 406-416. The sequences can define paths and/or patterns along which traffic traverses a network 104 from any number of nodes N selected as explained above with reference to operation 402. Thus, any number of sequences (e.g., similar to the sequence 206 and/or modified sequence 206' illustrated and described above with reference to FIGS. 2B-2F) can be generated by the walker via performing operations of the method 400, and these can be output at operation 418. It should be understood that this example embodiment is illustrative, and therefore should not be construed as being limiting in any way.

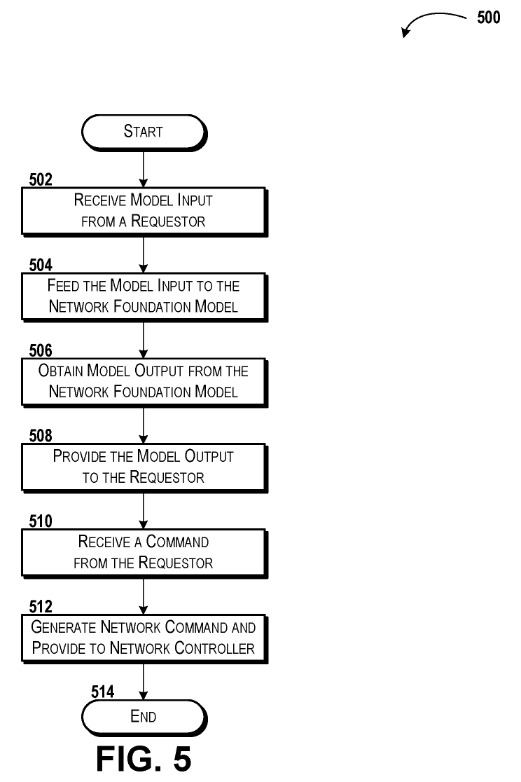

It can be appreciated that the network foundation model 114 can be trained on the one or more sequences output by the server computer 112 in operation 418 (and compiled into the data set at operation 312 of the method 300 and used to train the network foundation model 114 in operation 314). Thus, it can be appreciated that via performance of the operations of the methods 300 and 400, the network foundation model 114 can be created. Use of the network foundation model 114 for managing a network 104 will be illustrated and described herein with reference to FIG. 5. It should be understood that this example embodiment is illustrative, and therefore should not be construed as being limiting in any way.

From operation 418, the method 400 can proceed to operation 420. The method 400 can end at operation 420.

Turning now to FIG. 5, aspects of a method 500 for using a network foundation model to manage a network will be described in detail, according to an illustrative embodiment. The method 500 begins at operation 502. At operation 502, the server computer 112 can receive model input 126 from a requestor, for example the user device 102. The model input 126 obtained in operation 502 can correspond, for example, to a scenario that is being tested by a user or other entity. The model input 126 can include, for example, a hypothetical such as “what load may occur at a particular node N₁ if a hurricane happens at or near a particular node N₂.” Any hypothetical scenario may be posed by the model input 126, so it should be understood that this example is illustrative, and therefore should not be construed as being limiting in any way.

From operation 502, the method 500 can proceed to operation 504. At operation 504, the server computer 112 can feed the model input 126 received in operation 504 to the network foundation model 114. According to various embodiments of the concepts and technologies disclosed herein, the model input 126 can be provided as input to the network foundation model 114, and the network foundation model 114 can process (mathematically) the model input 126 using the network foundation model 114, and output an answer to the question posed by the model input 126 as the model output 128. It should be understood that this example embodiment is illustrative, and therefore should not be construed as being limiting in any way.

From operation 504, the method 500 can proceed to operation 506. At operation 506, the server computer 112 can obtain the model output 128 from the network foundation model 114. As noted above, the model output 128 can correspond to a result or output from the network foundation model 114 when fed the model input 126. Thus, operation 506 can correspond to the server computer 112 obtaining this output from the network foundation model 114. It should be understood that this example embodiment is illustrative, and therefore should not be construed as being limiting in any way.

From operation 506, the method 500 can proceed to operation 508. At operation 508, the server computer 112 can provide the model output 128 to the requestor, for example the user device 102. In various embodiments, the server computer 112 can transmit the model output 128 to the user device 102. In some other embodiments, the server computer 112 can provide the model output 128 to the user device 102 via a web page, a portal, or the like, which can be provided to the user device 102 via responding to a request (e.g., a HTTP request, or the like), via an application call, combinations thereof, or the like. Thus, operation 508 can correspond to the server computer 112 outputting the model output 128 in any manner that is obtainable and/or viewable by the user device 102. It should be understood that this example embodiment is illustrative, and therefore should not be construed as being limiting in any way.

From operation 508, the method 500 can proceed to operation 510. At operation 510, the server computer 112 can receive a command 130 from the requestor, for example the user device 102. The command 130 received in operation 510 can be based on the model output 128. For example, the command 130 can request a change to the network 104 and/or a portion thereof (e.g., a node N, a communication link L, a capacity, a bandwidth, combinations thereof, or the like). Thus, it can be appreciated that the command 130 obtained in operation 510 can correspond to a selection or the like made at the user device 102. It should be understood that this example embodiment is illustrative, and therefore should not be construed as being limiting in any way.

From operation 510, the method 500 can proceed to operation 512. At operation 512, the server computer 112 can generate a network command 132 and provide the network command 132 to a device on the network 104 such as, for example, the network controller 134. The server computer 112 create the network command 132 based on the command 130 received in operation 510. It can be appreciated that the network command 132 can include computer-executable instructions that, when executed by a recipient of the network command 132 (e.g., the network controller 134) can cause the recipient (e.g., the network controller 134) to modify the network 104 and/or a portion or component thereof (e.g., a node N, a communication L, or the like) based on the command 130. As such, it can be appreciated that the server computer 112 can modify the network 104 and/or a portion thereof based on output from the network foundation model 114, thereby managing the network 104 and/or a portion thereof. It should be understood that this example embodiment is illustrative, and therefore should not be construed as being limiting in any way.

From operation 512, the method 500 can proceed to operation 514. The method 500 can end at operation 514.

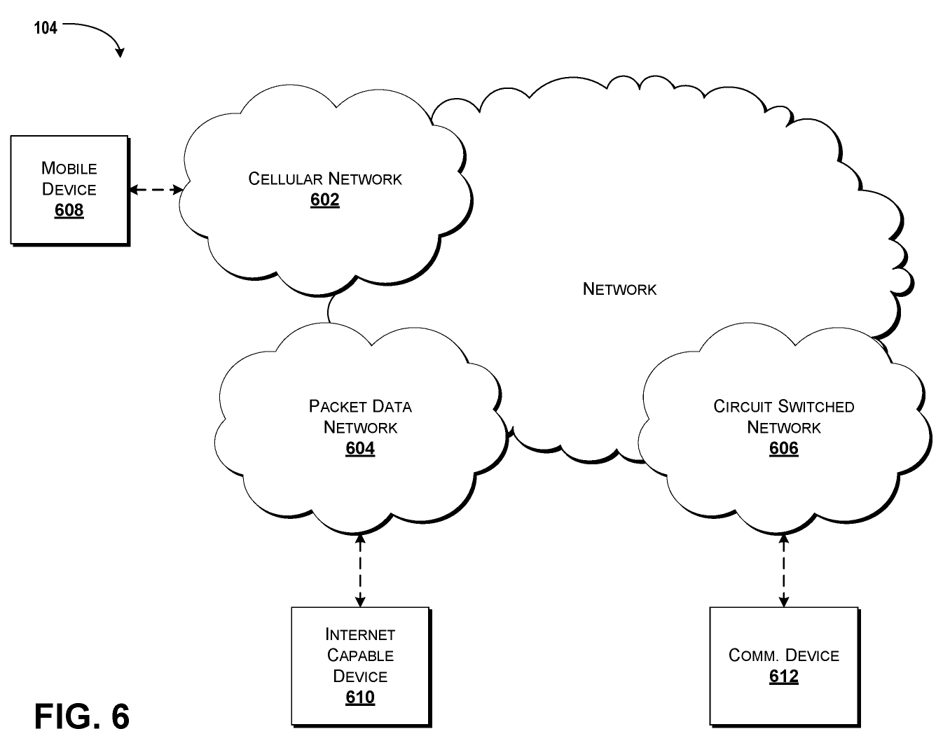

Turning now to FIG. 6, additional details of the network 104 are illustrated, according to an illustrative embodiment. The network 104 includes a cellular network 602, a packet data network 604, for example, the Internet, and a circuit switched network 606, for example, a publicly switched telephone network (“PSTN”). The cellular network 602 includes various components such as, but not limited to, base transceiver stations (“BTSs”), NodeB’s or eNodeB’s (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 602 also can include various interfaces between various components, as is generally understood. The cellular network 602 also includes radios and nodes for receiving and transmitting voice, data, and combinations thereof to and from radio transceivers, networks, the packet data network 604, and the circuit switched network 606.

A mobile communications device 608, such as, for example, a cellular telephone, a user equipment, a mobile terminal, a PDA, a laptop computer, a handheld computer, and combinations thereof, can be operatively connected to the cellular network 602. The cellular network 602 can be configured as a 2G GSM network and can provide data communications via GPRS and/or EDGE. Additionally, or alternatively, the cellular network 602 can be configured as a 3G UMTS network and can provide data communications via the HSPA protocol family, for example, HSDPA, EUL (also referred to as HSUPA), and HSPA+. The cellular network 602 also is compatible with 4G mobile communications standards, 5G mobile communications standards, 6G mobile communication standards, other mobile communications standards, and evolved and future mobile communications standards. Moreover, the cellular network 602 may facilitate communications over various channel access methods (which may or may not be used by the aforementioned standards) including, but not limited to, TDMA, FDMA, W-CDMA, OFDM, SDMA, and the like. In addition, the cellular network 602 may facilitate data communications using GPRS, EDGE, the HSPA protocol family including HSDPA, EUL or otherwise termed HSUPA, HSPA+, and various other current and future wireless data access standards. Because additional and/or alternative mobile communications standards may be used in accordance with various embodiments of the concepts and technologies disclosed herein, it should be understood that these example embodiments are illustrative, and therefore should not be construed as being limiting in any way.

The packet data network 604 includes various devices, for example, servers, computers, databases, and other devices in communication with one another, as is generally known. The packet data network 604 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (POTS). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable devices 610, for example, a PC, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610. In the specification, the network 104 is used to refer broadly to any combination of the networks 602, 604, 606. It should be appreciated that substantially all of the functionality described with reference to the network 104 can be performed by the cellular network 602, the packet data network 604, and/or the circuit switched network 606, alone or in combination with other networks, network elements, and the like.

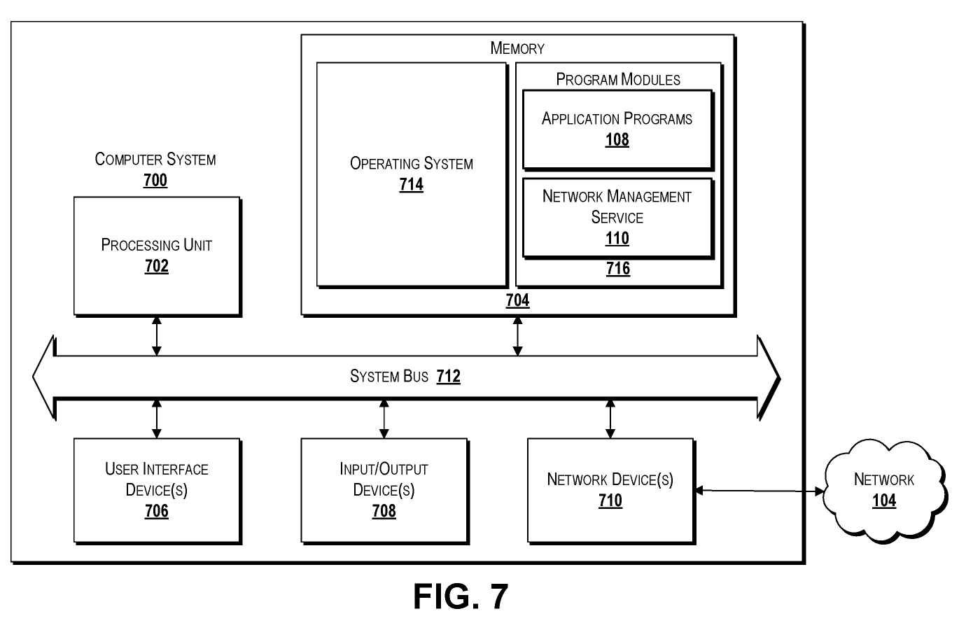

FIG. 7 is a block diagram illustrating a computer system 700 configured to provide the functionality described herein for providing network management using a network foundation model, in accordance with various embodiments of the concepts and technologies disclosed herein. The computer system 700 includes a processing unit 702, a memory 704, one or more user interface devices 706, one or more input/output (“I/O”) devices 708, and one or more network devices 710, each of which is operatively connected to a system bus 712. The system bus 712 can enable bi-directional communication between the processing unit 702, the memory 704, the user interface devices 706, the I/O devices 708, and the network devices 710.

The processing unit 702 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 704 communicates with the processing unit 702 via the system bus 712. In some embodiments, the memory 704 is operatively connected to a memory controller (not shown) that enables communication with the processing unit 702 via the system bus 712. The memory 704 includes an operating system 714 and one or more program modules 716. The operating system 714 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 716 may include various software and/or program modules described herein. In some embodiments, for example, the program modules 716 include the application programs 108 and/or the network management service 110. These and/or other programs can be embodied in computer-readable media containing instructions that, when executed by the processing unit 702, perform one or more of the methods 300, 400, and 500 described in detail above with respect to FIGS. 3-5 and/or other functionality as illustrated and described herein. It can be appreciated that, at least by virtue of the instructions embodying the methods 300, 400, and 500, and/or other functionality illustrated and described herein being stored in the memory 704 and/or accessed and/or executed by the processing unit 702, the computer system 700 is a special-purpose computing system that can facilitate providing the functionality illustrated and described herein. According to embodiments, the program modules 716 may be embodied in hardware, software, firmware, or any combination thereof. Although not shown in FIG. 7, it should be understood that the memory 704 also can be configured to store the network foundation model 114, the network data 116, the network topology 122, the network-flow model 124, the model input 126, the model output 128, the command 130, the network command 132, and/or other data, if desired.

By way of example, and not limitation, computer-readable media may include any available computer storage media or communication media that can be accessed by the computer system 700. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 700. In the claims, the phrase “computer storage medium” and variations thereof does not include waves or signals per se and/or communication media.

The user interface devices 706 may include one or more devices with which a user accesses the computer system 700. The user interface devices 706 may include, but are not limited to, computers, servers, personal digital assistants, cellular phones, or any suitable computing devices. The I/O devices 708 enable a user to interface with the program modules 716. In one embodiment, the I/O devices 708 are operatively connected to an I/O controller (not shown) that enables communication with the processing unit 702 via the system bus 712. The I/O devices 708 may include one or more input devices, such as, but not limited to, a keyboard, a mouse, or an electronic stylus. Further, the I/O devices 708 may include one or more output devices, such as, but not limited to, a display screen or a printer.

The network devices 710 enable the computer system 700 to communicate with other networks or remote systems via a network, such as the network 104. Examples of the network devices 710 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

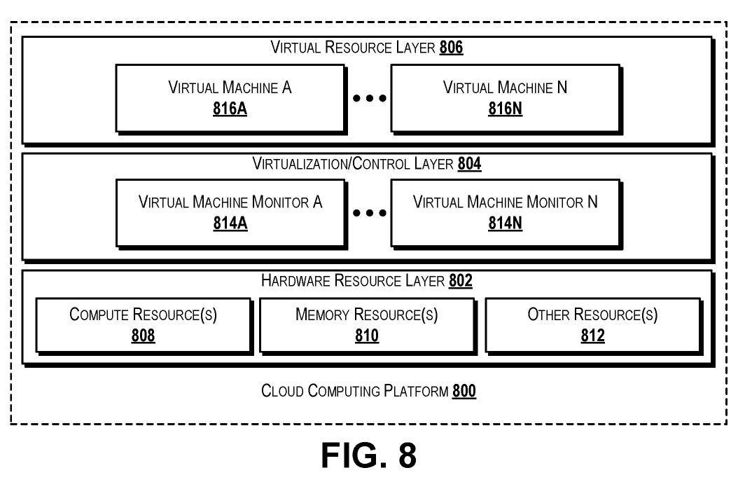

FIG. 8 illustrates an illustrative architecture for a cloud computing platform 800 that can be capable of executing the software components described herein for providing network management using a network foundation model and/or for interacting with the network management service 110. Thus, it can be appreciated that in some embodiments of the concepts and technologies disclosed herein, the cloud computing platform 800 illustrated in FIG. 8 can be used to provide the functionality described herein with respect to the user device 102, the network nodes on the network 104 and/or other networks, the server computer 112, the data store 118, the network monitor 120, and/or the network controller 134.

The cloud computing platform 800 thus may be utilized to execute any aspects of the software components presented herein. Thus, according to various embodiments of the concepts and technologies disclosed herein, the application programs 108 and/or the network management service 110 can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the application programs 108 and/or the network management service 110 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, California, and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the application programs 108, the network management service 110, and/or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, the network foundation model 114, the network data 116, the network topology 122, the network-flow model 124, the model input 126, the model output 128, the command 130, the network command 132, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for network management using a network foundation model have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
selecting, in a directed graph representing a network topology, a component that corresponds to a node on a network, wherein the component is connected to an edge that corresponds to a communication link on the network, and wherein the edge has a weight that represents a probability that traffic flows from the node to a further node via the communication link,
placing, on the component, a walker that collects, by the walker and at the component, a state of the node, an identity of the node, and a time at which the state is collected,
determining, at the component, the weight,
selecting, by the walker, a next component based on the weight, wherein the walker traverses the network via the edge if the next component is available, and wherein the walker selects a different component based on the weight if the next component is not available,
collecting, by the walker and at the next component, a further state of the further node, a further identity of the further node, and a further time at which the further state is collected,
outputting, by the walker, a sequence that reflects the state of the node, the time at which the state of the node is collected, the further state of the further node, and the further time at which the further state is collected, and
training, based on the sequence, a network foundation model for the network.

2. The system of claim 1, wherein the computer-executable instructions, when executed by the processor, cause the processor to perform operations further comprising:
determining, by the walker, if criteria specified for the walker are met; and
in response to determining that the criteria specified for the walker are not met, determining edge weights for edges that connect to the further node and again traversing the network via a highest weighted edge of the edges.

3. The system of claim 1, wherein the computer-executable instructions, when executed by the processor, cause the processor to perform operations further comprising:
receiving, from a requestor, model input that represents a hypothetical network scenario;
feeding, to the network foundation model, the model input to obtain model output;
providing the model output to the requestor; and
receiving, from the requestor and based on the model output, a command that specifies an action to take on the network based on the model output.

4. The system of claim 3, wherein the computer-executable instructions, when executed by the processor, cause the processor to perform operations further comprising:
generating, based on the command, a network command comprising instructions that, when executed by a network controller, cause the network controller to modify the network; and
providing, to the network controller, the network command.

5. The system of claim 1, wherein the computer-executable instructions, when executed by the processor, cause the processor to perform operations further comprising:
detecting a request to create the network foundation model;
obtaining network data that describes nodes of the network, communication links between the nodes, and events at the nodes and communication links; and
creating the network topology and network-flow model based on the network data, wherein the network foundation model is generated based on the network topology and the network-flow model.

6. The system of claim 5, wherein the network topology comprises the directed graph, and wherein the network-flow model describes traffic among the nodes of the network.

7. The system of claim 5, wherein the network data is obtained from a network monitor that outputs a stream of events occurring on the network, and wherein the network data comprises netflow data.

8. A method comprising:
selecting, by a computer comprising a processor that provides a walker and in a directed graph representing a network topology, a component that corresponds to a node on a network, wherein the component is connected to an edge that corresponds to a communication link on the network, and wherein the edge has a weight that represents a probability that traffic flows from the node to a further node via the communication link;
placing, by the processor and on the component, the walker, wherein the walker collects, at the component, a state of the node, an identity of the node, and a time at which the state is collected;
determining, by the walker and at the component, the weight;
selecting, by the walker, a next component based on the weight, wherein the walker traverses the network via the edge if the next component is available, and wherein the walker selects a different component based on the weight if the next component is not available;
collecting, by the walker and at the next component, a further state of the further node, a further identity of the further node, and a further time at which the further state is collected;
outputting, by the walker, a sequence that reflects the state of the node, the time at which the state of the node is collected, the further state of the further node, and the further time at which the further state is collected; and
training, based on the sequence, a network foundation model for the network.

9. The method of claim 8, further comprising:
determining, by the walker, if criteria specified for the walker are met; and
in response to determining that the criteria specified for the walker are not met, determining edge weights for edges that connect to the further node and again traversing the network via a highest weighted edge of the edges.

10. The method of claim 8, further comprising:
receiving, from a requestor, model input that represents a hypothetical network scenario;
feeding, to the network foundation model, the model input to obtain model output;
providing the model output to the requestor; and
receiving, from the requestor and based on the model output, a command that specifies an action to take on the network based on the model output.

11. The method of claim 10, further comprising:
generating, based on the command, a network command comprising instructions that, when executed by a network controller, cause the network controller to modify the network; and
providing, to the network controller, the network command.

12. The method of claim 8, further comprising:
detecting a request to create the network foundation model;
obtaining network data that describes nodes of the network, communication links between the nodes, and events at the nodes and communication links; and
creating the network topology and network-flow model based on the network data, wherein the network foundation model is generated based on the network topology and the network-flow model.

13. The method of claim 12, wherein the network topology comprises the directed graph, and wherein the network-flow model describes traffic among the nodes of the network.

14. A computer storage medium having computer-executable instructions stored thereon that, when executed by a processor, cause the processor to perform operations comprising:
selecting, in a directed graph representing a network topology, a component that corresponds to a node on a network, wherein the component is connected to an edge that corresponds to a communication link on the network, and wherein the edge has a weight that represents a probability that traffic flows from the node to a further node via the communication link;
placing, on the component, a walker that collects, by the walker and at the component, a state of the node, an identity of the node, and a time at which the state is collected;
determining, at the component, the weight;
selecting, by the walker, a next component based on the weight, wherein the walker traverses the network via the edge if the next component is available, and wherein the walker selects a different component based on the weight if the next component is not available;
collecting, by the walker and at the next component, a further state of the further node, a further identity of the further node, and a further time at which the further state is collected;
outputting, by the walker, a sequence that reflects the state of the node, the time at which the state of the node is collected, the further state of the further node, and the further time at which the further state is collected; and
training, based on the sequence, a network foundation model for the network.

15. The computer storage medium of claim 14, wherein the computer-executable instructions, when executed by the processor, cause the processor to perform operations further comprising:
determining, by the walker, if criteria specified for the walker are met; and
in response to determining that the criteria specified for the walker are not met, determining edge weights for edges that connect to the further node and again traversing the network via a highest weighted edge of the edges.

16. The computer storage medium of claim 14, wherein the computer-executable instructions, when executed by the processor, cause the processor to perform operations further comprising:
receiving, from a requestor, model input that represents a hypothetical network scenario;
feeding, to the network foundation model, the model input to obtain model output;
providing the model output to the requestor; and
receiving, from the requestor and based on the model output, a command that specifies an action to take on the network based on the model output.

17. The computer storage medium of claim 16, wherein the computer-executable instructions, when executed by the processor, cause the processor to perform operations further comprising:
generating, based on the command, a network command comprising instructions that, when executed by a network controller, cause the network controller to modify the network; and
providing, to the network controller, the network command.

18. The computer storage medium of claim 14, wherein the computer-executable instructions, when executed by the processor, cause the processor to perform operations further comprising:
detecting a request to create the network foundation model;
obtaining network data that describes nodes of the network, communication links between the nodes, and events at the nodes and communication links; and
creating the network topology and network-flow model based on the network data, wherein the network foundation model is generated based on the network topology and the network-flow model.

19. The computer storage medium of claim 18, wherein the network topology comprises the directed graph, and wherein the network-flow model describes traffic among the nodes of the network.

20. The computer storage medium of claim 18, wherein the network data is obtained from a network monitor that outputs a stream of events occurring on the network, and wherein the network data comprises netflow data.
